(19) United States
(12) Patent Application Publication
(10) Pub. No.: US 2006/0149619 A1
(43) Pub. Date: Jul. 6, 2006

(54) METHOD AND SYSTEM FOR INCENTIVIZING VEHICLE ACQUISITION

(75) Inventor: Wynne William, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/905,450

(22) Filed: Jan. 5, 2005

(51) Int. Cl. G06Q 30/00

(52) U.S. Cl. 705/14

(57) ABSTRACT

A method for incentivizing acquisition of a vehicle including offering a non-cash incentive currency having a conversion component and a redemption component. The conversion component is convertible into a cash incentive and the redemption component is redeemable for a non-cash incentive offering.

### BACKGROUND OF THE INVENTION

1. Field of the Invention

One aspect of the present invention generally relates to a method and system for incentivizing vehicle acquisition, and more specifically, a method and system for incentivizing vehicle purchase and lease.

2. Background Art

Incentives have a long and storied history within the automotive industry. Dating back to 1914, Ford Motor Company created the first rebate, offered on the Model T. According to the rebate offer, if consumers collectively purchased a certain number of Model T's, each purchaser would receive a rebate amount. The rebate program proved to be wildly successful, and propelled Ford to the forefront of innovative incentive offerings.

Since that time, Ford and other original equipment manufacturers (OEMs) have inundated the automotive landscape with a variety of incentive offerings in an effort to maintain market share and profits. Over time, consumers have become desensitized to incentive offerings for any number of reasons. Notably, consumers often believe that the value of incentive packages offered by competing OEMs is basically equal, thereby negating the competitive advantage of such incentives. Moreover, consumers are unmotivated to analyze the true value of an incentive package since the packages are often complicated and time consuming to fully understand. Consequently, OEMs have been left searching for innovative, value added incentive programs that appeal to consumers in a straight forward manner.

Other industries have had success in bringing refreshing incentive concepts to the marketplace. For example, companies in the airline and hotel industries have introduced customer reward programs that offer consumers points in return for using their services and/or products, i.e. air travel and lodging. The reward points are redeemable at a later time for reduced price air fare or lodging.

In light of the foregoing, what is needed is a new and innovative method and system of incentivizing vehicle acquisition. What is also needed is a method and system of incentivizing vehicle purchase and/or lease.

### SUMMARY OF THE INVENTION

One aspect of the present invention is a truly unique method and system for incentivizing vehicle acquisition. Another aspect of the present invention is a method and system for incentivizing vehicle purchase and lease.

According to one embodiment of the present invention, a method for incentivizing acquisition of a vehicle is disclosed. The vehicle acquisition can be a vehicle purchase or vehicle lease. The method includes offering a non-cash incentive currency having a conversion component and a redemption component. The conversion component is convertible into a cash incentive and the redemption component is redeemable for a non-cash incentive offering.

The method can further include redeeming at least a portion of the redemption component at about the time of inception of the vehicle acquisition. Moreover, the method can include converting at least a portion of the conversion component into the cash incentive. Non-limiting examples of non-cash offerings include merchandise, travel, extraordinary access, and vehicle products and/or services. The cash incentive can be consumer cash. The conversion component can include a maximum conversion percentage. In certain embodiments, the maximum conversion percentage can be between about 40% and about 80%.

According to another embodiment of the present invention, a computer-implemented system for incentivizing vehicle acquisition is disclosed. The system can include one or more computers configured to: offer a non-cash incentive currency having a conversion component and a redemption component. The conversion component is convertible into a cash incentive and the redemption component is redeemable for a non-cash incentive offering.

The one or more computers can be further configured to offer the non-cash incentive currency through a web-based interface. The one of more computers can also be configured to redeem at least a portion of the redemption component at about the time of inception of the vehicle acquisition. Other configurations include converting at least a portion of the conversion component into the cash incentive and managing a consumer account having an amount of non-cash incentive currency. The web-based interface includes forms for displaying information relating to the non-cash incentive offerings. Non-limiting examples of offerings include merchandise and travel. The cash incentive can be consumer cash.

According to yet another embodiment of the present invention, a non-cash incentive instrument is disclosed. The instrument includes a conversion component being convertible into a cash incentive and a redemption component being redeemable for a non-cash incentive offering. The conversion component can include a maximum conversion percentage. The maximum conversion percentage can be between about 40% and about 80%. The cash incentive can be consumer cash. The non-cash incentive offering can be merchandise.

The above and other objects, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings which:

FIG. 1 depicts a flowchart of an incentive offering according to an embodiment of the present invention;

FIG. 2 is a conceptual diagram of a non-cash incentive currency for incentivizing vehicle acquisition according one embodiment of the present invention;

FIG. 3 is a conceptual diagram 30 depicting examples of non-cash offerings according to one embodiment of the present invention; and

FIG. 4 is a computer system for implementing a method of incentivizing vehicle acquisition according to one system embodiment of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. Therefore, specific functional details herein are not to be interpreted as limiting, but merely as a representative basis for the claims and/or as a representative basis for teaching one of ordinary skill in the art to variously employ the present invention.

Vehicle original equipment manufacturers (“OEMs”) offer incentive packages to entice a consumer to purchase or lease a vehicle manufactured by the OEM. In certain situations, vehicle dealers also offer incentive packages. It is understood that vehicle dealers or dealerships can refer to an entity which sells and leases vehicles manufactured by the OEM.

One such example of an incentive package is an instant rebate, otherwise referred to herein as customer cash, redeemable by the consumer at inception of a purchase or lease arrangement. In the situation of vehicle purchase, the consumer cash amount is deducted from the selling price of the vehicle. For example, OEM A can offer $4,000 in consumer cash applicable to the purchase of vehicles A, B, and C, each vehicle being a different model, but having a selling price of about $35,000. The consumer can choose to purchase vehicle B and apply the $4,000 of consumer cash to the purchase so that the actual selling price is $31,000. The consumer can pay the actual selling price in cash or finance the amount. In the situation of a vehicle lease, the consumer cash can be applied to the amount due at signing or to the payments being made under the lease arrangement. For example, OEM A can offer $1,500 in consumer cash applicable to the lease of vehicles D, E and F. Each of these vehicles has an amount of $2,000 due at signing, a three year lease term, and a $400 monthly payment. The consumer can choose to lease vehicle F and apply the $1,500 to the due at signing amount so that the actual amount due at signing is $500.

Consumer cash may be successful in enticing a consumer to purchase the OEM's vehicle since it can represent a substantial cash savings relative to the selling price, or due at signing amount under a lease arrangement. In the scenarios described above, the total amount of consumer cash is applied dollar for dollar to the selling price (or due at signing amount or periodic payments in the case of a lease). Under this type of incentive package, each dollar of value imparted on the consumer by virtue of the consumer cash represents a dollar in cost to the OEM and/or dealer.

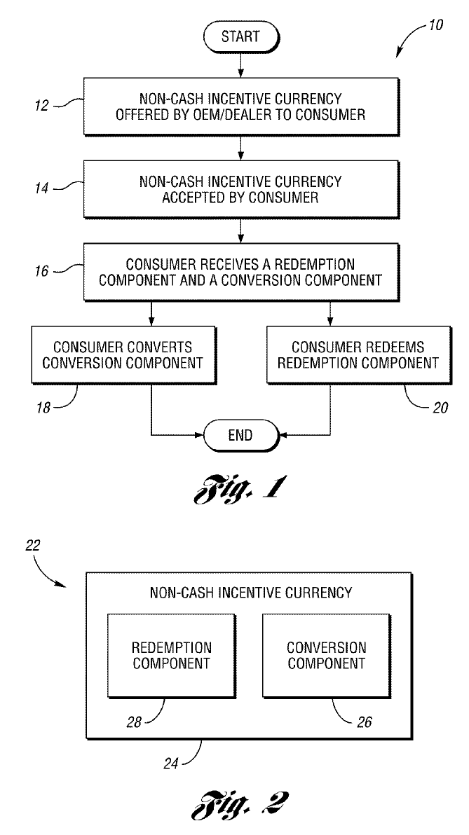

In certain embodiments of the present invention, an incentive package is provided that maintains the dollar value to the consumer while decreasing the OEM/dealer cost. FIG. 1 depicts a flowchart of an incentive offering according to an embodiment of the present invention. The incentive package includes a non-cash incentive currency, having at least two components. According to block 12 of flowchart 10, an OEM or dealer offers the non-cash incentive currency to a consumer. The consumer may accept the non-cash incentive currency (block 14) to receive a redemption component and a conversion component (block 16).

FIG. 2 shows conceptual diagram 22 of non-cash incentive currency 24 for incentivizing vehicle acquisition according one embodiment of the present invention. The first component 26 of the incentive currency is a conversion into a cash incentive, for example, consumer cash. The second component 28 of the incentive currency is a redemption for a non-cash offering. In certain embodiments of the present invention, the redemption can occur at about the same time that the vehicle is being purchased or leased. Advantageously, the non-cash incentive currency offers an alternative to consumer cash while delivering the same value to the consumer with decreased costs to the OEM/dealer.

The conversion component can give the consumer the right to convert a maximum conversion percentage of the non-cash incentive currency into consumer cash, as depicted by block 18 of flowchart 10. For example, the OEM can offer the consumer $4,000 in non-cash incentive currency. In this example, the maximum conversion percentage can be 75%. Therefore, $3,000, or 75% of the non-cash incentive currency, can be converted into consumer cash, while the remaining $1,000, i.e. 25%, is redeemable for a non-cash offering. It should be understood that other maximum conversion percentages can be used depending on the incentive package and the vehicles involved. In certain embodiments, the maximum redemption percentage can be in the range of about 40% to about 80%.

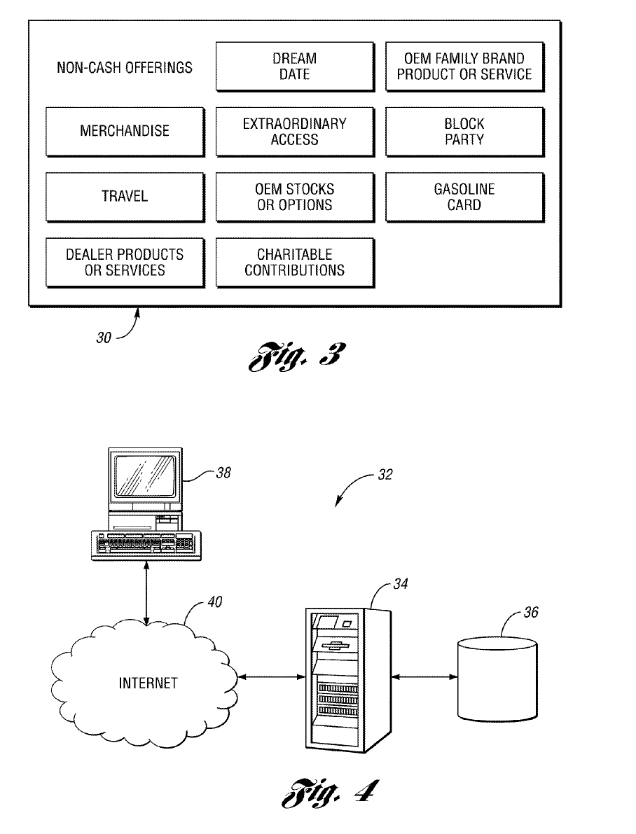

The redemption component of the non-cash incentive currency can give the consumer the right to redeem a percentage of the non-cash incentive currency for a non-cash offering, as depicted by block 20 of flowchart 10. There are many examples of non-cash offerings that can be used in conjunction with the present invention. FIG. 3 is conceptual diagram 30 depicting examples of non-cash offerings.

For example, merchandise, and in some instances, premium merchandise, can be used as non-cash incentive currency. Premium merchandise can include, but is not limited to, OEM branded novelty items, OEM vehicle accessories, vehicle publications, etc. Non-limiting examples of OEM branded novelty items include die cast vehicle replicas, clothing, posters, glasses, golf bags, etc. Non-limiting examples of OEM vehicle accessories include bike racks, hitch accessories, GPS-navigation units, floor mats, fender trim, spare tire covers, rear window graphics, exhaust tips, etc. Non-limiting examples of vehicle publications include vehicle magazine subscriptions, vehicle repair manuals, vehicle history books, etc. Many times, the OEM has already absorbed the cost of producing these items, and has priced the items to sell at a selling price higher than the cost so that a profit can be realized.

An example follows for illustrative purposes. The OEM may produce, or have produced by an outside company, a limited edition die cast miniature replica vehicle, for example, a 1965 Ford Mustang. The cost to produce this replica is $500. The OEM, through its marketing wing, may offer this miniature replica at a retail price of $1,000, which represents the value to the consumer. In the example given above where the consumer has an additional $1,000 in non-cash incentive currency left after converting 75% to consumer cash, the consumer can use the addition $1,000 to redeem the miniature replica. This redemption represents a source of cost reduction for the OEM relative to the use of consumer cash while delivering the same value to the consumer. In other words, consumer cash has a cost to value ratio of 1:1 while the redemption component of the non-cash incentive currency has a cost to value ratio of 0.5:1. Using the example above, the overall cost to value ratio factoring in both components is 0.875:1 (or 7:8). In other words, the OEM's cost is $3,000 (conversion component) and $500 (redemption component) for a total of $3,500, while the value is $3,000 (conversion component) and $1,000 (redemption component) for a total of $4,000. Moreover, the OEM's brand recognition is reinforced by the consumer's acquisition of the miniature replica.

Another example of an offering for the redemption component for the non-cash incentive currency can be travel, and in certain embodiments, premium travel. For example, the OEM can use its size and business influence to negotiate better prices on vacations than available to an individual consumer. The price negotiated by the OEM represents the OEM's cost. The price available to the individual consumer represents the value. Non-limiting examples of vacations include golf vacations, fishing vacations, safari expeditions, whale watching trips, etc.

An illustrative example follows. The OEM negotiates a bulk discount on a four-day vacation to Myrtle Beach, N. C. The OEM purchases 100 vacations for $750 per vacation. An individual consumer would be able to purchase a similar trip for $1,000. In the example given above where the consumer has an additional $1,000 in incentive currency left after converting 75% to consumer cash, the consumer can use the addition $1,000 to redeem the Myrtle Beach vacation. This redemption represents a source of cost reduction for the OEM relative to the use of consumer cash while delivering the same value to the consumer. In other words, consumer cash has a cost to value ratio of 1:1 while the redemption component of the non-cash incentive currency has a cost to value ratio of 0.75:1 (or 3:4). Using the example above, the overall cost to value ratio factoring in both components is 0.9375:1 (or 15:16). In other words, the OEM's cost is $3,000 (conversion component) and $750 (redemption component) for a total of $3,750, while the value is $3,000 (conversion component) and $1,000 (redemption component) for a total of $4,000.

Yet another example of an offering is dealer products or services. Dealer products can include vehicle parts, for example, engines, transmissions, windshields, tires, etc. Dealer services can include vehicle services, for example, oil changes, engine tuneups, regular maintenance, etc.

An illustrative example follows. A vehicle consumer may want to purchase a heavy duty truck that has stock tires. The consumer may want to upgrade the tires for off-roading purposes. A dealer may offer this upgrade (tires and labor) for $1,000, although the cost to the dealer is only $500. In the example given above where the consumer has an additional $1,000 in incentive currency left after converting 75% to consumer cash, the consumer can use the addition $1,000 to redeem the tire upgrade. This redemption represents a source of cost reduction for the OEM relative to the use of consumer cash while delivering the same value to the consumer. In other words, consumer cash has a cost to value ratio of 1:1 while the redemption component of the non-cash incentive currency has a cost to value ratio of 0.5:1 (or 1:2). Using the example above, the overall cost to value ratio factoring in both components is 0.875:1 (or 7:8). In other words, the OEM's cost is $3,000 (conversion component) and $500 (redemption component) for a total of $3,500, while the value is $3,000 (conversion component) and $1,000 (redemption component) for a total of $4,000.

According to another embodiment of the present invention, the consumer can retain the $1,000 of non-cash incentive currency after purchasing the heavy duty truck with stock tires. In this example, the consumer may want to forego upgrading the tires on the vehicle being currently purchased, and retain the $1,000 for the next vehicle purchase or lease. In certain embodiments, the dealer may offer a redemption coupon in exchange for the $1,000. The redemption coupon may represent a $1,500 value in upgrades to the consumer, which is applicable to their next vehicle acquisition. Advantageously, this redemption coupon can be offered to encourage loyalty to the consumer at no present cost to the OEM/dealership.

Yet another example of an offering is extraordinary access. Non-limiting examples of extraordinary access offerings including playing a round of golf with a PGA member, driving a race car during the week preceding a NASCAR event, or driving a vehicle on an OEM's proving grounds, picking up the consumer's new vehicle at the assembly plant, participating in final assembly of the consumer's new vehicle, attending driving school, etc.

Another example of an offering is OEM stocks or options. In one embodiment, the offering could be available to dealership salespeople. The OEM can fund an investment company, which could administer a reward of stock or options based on a target being met. An example of a target is a number of sales made by one or more dealerships of a period of time.

Another example of a non-cash offering is a charitable contribution to a charity or community service organization (e.g. a local school). In certain embodiments, the OEM could provide a percentage of matching funds.

Yet another example of a non-cash offering is providing an OEM family brand product or service. For example, Hertz is within the Ford family of brands. The non-cash offering could be a Hertz No. 1 Gold Club membership.

Another example of a non-cash offering is a block party offered to the consumer for the consumer's neighborhood or neighborhood of the consumer's choosing.

Yet another example of a non-cash offering is a gasoline card. In certain embodiments, the gasoline card is redeemable for a certain volume of gasoline, for example 1,000 gallons. Beneficially, the gasoline card could be used to help make consumer's insensitive to gas price fluctuations.

Yet another example of a non-cash offering is a dream date for a couple. The dream date could include a sport car rental for the evening and dinner for two.

In certain embodiments of the present invention, the consumer can also bank the non-cash incentive currency for future use. Using the base example above, the consumer used $3,000 to convert the non-cash incentive currency into consumer cash. The consumer can bank the remaining $1,000 for later use, i.e. for another vehicle purchase or use as the redemption component. Further, the consumer can also transfer the remaining non-cash currency to another individual, for example, friends and/or family. In certain embodiments, the OEM can set up a proprietary account management system, and in certain situations, a computer system, to administer consumers' non-cash incentive currency accounts. FIG. 4 shows computer system 32 for implementing a method of incentivizing vehicle acquisition according to one embodiment of the present invention. Computer system 32 includes server 34 in communication with database 36 such that server 34 can store information from database 36 and retrieve data from database 36. The data stored on database 36 includes, but is not limited to, consumer non-cash incentive currency accounts and information relating to offerings. Server 34 is also in communication with consumer computer 38 via Internet 40. Server 34 can serve web-based interfaces that are displayed on consumer computer 38. The OEM can customize its existing computer system for managing its retail installment contracts and financing to accommodate the functionality of the non-cash incentive currency.

Further, the present invention includes the ability for a consumer having non-cash incentive currency to manage the account through a web-based interface. The web-based interface can have functionality to generate, update, and/or display offerings in a catalogue format. The web-based interface can also be used to redeem offerings and convert the non-cash incentive currency into consumer cash. The web-based system can also be in communication with a fulfillment system via a vendor or vertical integration so that redemptions can be fulfilled.

In certain embodiments, the relationship created between the OEM/dealership and the consumer receiving non-cash incentive currency can generate a platform for consumer relations management. For example, the OEM/dealership can send advertising materials for vehicles and non-cash offerings to consumers holding non-cash incentive currency. The non-cash incentive currency can be used in conjunction with acquiring the advertised items.

While the best mode for carrying out the invention has been described in detail, those familiar with the art to which this invention relates will recognize various alternative designs and embodiments for practicing the invention as defined by the following claims.

What is claimed is:

1. A method for incentivizing acquisition of a vehicle, the method comprising:
offering a non-cash incentive currency having a conversion component and a redemption component, the conversion component being convertible into a cash incentive and the redemption component being redeemable for a non-cash incentive offering.

2. The method of claim 1 further comprising redeeming at least a portion of the redemption component at about the time of inception of the vehicle acquisition.

3. The method of claim 1 further comprising converting at least a portion of the conversion component into the cash incentive.

4. The method of claim 1 wherein the non-cash incentive offering is selected from the group consisting of merchandise, travel, extraordinary access, or vehicle products and/or services.

5. The method of claim 1 wherein the cash incentive is consumer cash.

6. The method of claim 1 wherein the conversion component includes a maximum conversion percentage.

7. The method of claim 6 wherein the maximum conversion percentage is between about 40% and about 80%.

8. The method of claim 1 wherein the vehicle acquisition is a vehicle purchase or a vehicle lease.

9. The method of claim 1 wherein the redemption component is redeemable for a redemption coupon.

10. The method of claim 9 wherein the redemption coupon is applicable to the consumer's next vehicle acquisition.

11. A computer-implemented system for incentivizing vehicle acquisition, the system including one or more computers, the one or more computers configured to:
offer a non-cash incentive currency having a conversion component and a redemption component, the conversion component being convertible into a cash incentive and the redemption component being redeemable for a non-cash incentive offering.

12. The system of claim 11 wherein the one or more computers are configured to offer the non-cash incentive currency through a web-based interface.

13. The system of claim 11 wherein the one of more computers is further configured to redeem at least a portion of the redemption component at about the time of inception of the vehicle acquisition.

14. The system of claim 11 wherein the one or more computers is further configured to convert at least a portion of the conversion component into the cash incentive.

15. The system of claim 11 wherein the one or more computers is further configured to manage a consumer account having an amount of non-cash incentive currency.

16. The system of claim 12 wherein the web-based interface includes forms for displaying information relating to the non-cash incentive offerings.

17. The system of claim 16 wherein the non-cash incentive offering is selected from the group consisting of merchandise, travel or OEM stock or options.

18. The system of claim 11 wherein the cash incentive is consumer cash.

19. A non-cash incentive instrument comprising:
a conversion component being convertible into a cash incentive; and
a redemption component being redeemable for a non-cash incentive offering.

20. The instrument of claim 19 wherein the cash incentive is consumer cash.
